(19) United States
(12) Patent Application Publication
(10) Pub. No.: US 2002/0004192 A1
(43) Pub. Date: Jan. 10, 2002

(54) DECOLORIZED ANIMAL BLOOD PRODUCTS AND METHOD OF MAKING SAME

(76) Inventors: JOHN H. LEE, OLATHE, KS (US); JOSEPH D. HAHN, KANSAS CITY, MO (US); ROBERT C. MUSSER, SHAWNEE, KS (US)

Correspondence Address: HOVEY WILLIAMS TIMMONS AND COLLINS, 2405 GRAND SUITE 400, KANSAS CITY, MO, 64108

(21) Appl. No.: 09/265,249

(22) Filed: Mar. 9, 1999

(51) Int. Cl. A01N 1/02

(52) U.S. Cl. 435/2

(57) ABSTRACT

A decolorized blood product and method for making the product is provided. Broadly, the products are formed by mixing a low concentration of an oxidant with a starting composition comprising a blood component such as red blood cells without subjecting the composition to a pH reversal. Just prior to the mixing step, the starting composition is preferably heated to a temperature of from about 50-80° C. so as to inactivate the peroxidase enzymes in the composition. The resulting products are light in color, have a mild flavor, and retain a high yield of the protein, and iron of the starting compositions. Furthermore, the products formed by this method do not contain undesirable by-products such as free heme or excess oxidant.

### BACKGROUND OF THE INVENTION

1. Field of the Invention

The present invention is broadly concerned with decolorized blood products and methods of forming the same. More particularly, the blood products are formed by mixing low concentrations of oxidants such as H₂O₂ with a starting composition comprising red blood cells without subjecting the composition to the prior art “pH reversal” processes. Preferably, the starting compositions are heated to a sufficient temperature for a sufficient period of time so as to inactivate the naturally occurring peroxidase enzymes of the starting composition. The methods of the invention result in products having a light color and mild flavor which retain most of the protein, fat, and iron present in the starting composition. Furthermore, the methods do not result in undesirable characteristics such as increased ash levels or residual peroxide activity.

2. Description of the Prior Art

Animal blood products are excellent sources of protein. Red blood cells contain about 92% by weight protein, and plasma contains about 78% protein. Plasma is typically separated from red blood cells by centrifugation and is a good source of globulins, albumin, and other plasma proteins. Plasma products have a light color and are often used as a supplement in food products. However, because of the intense color associated with red blood cells, whole blood and red blood cell products have limited applications in the formulation of food, feed, milk replacer, pet food, and other products.

Heme is the source of the dark red color in blood products. There are numerous methods by which heme can be removed from red blood cell-containing products, including extraction, precipitation, hydrolysis, and centrifugation processes. However, protein recovery is diminished by these processes. Other negative factors associated with these processes include high costs, the formation of undesirable by-products, high ash level in the final product, and the use of additional chemicals. There is a need for an inexpensive process by which red blood cell-containing products can be decolorized to yield products having high protein and iron concentrations and low ash levels.

### SUMMARY OF THE INVENTION

The instant invention overcomes the above problems and provides decolorized blood products which retain most of the iron and protein of the starting blood compositions. The invention also provides methods for forming these products.

In more detail, the products are formed by decolorizing a starting composition comprising a blood component which includes heme, in red blood cells or otherwise. These blood components are preferably selected from the group consisting of whole blood, red blood cell fractions, plasma (which contains heme as a natural constituent or as a contaminant), and mixtures thereof The blood components can be obtained from any source, including swine, cattle, turkey, chickens, goats, and other animals.

This decolorization is carried out by mixing less than about 3% by weight, preferably less than about 1.0% by weight, and more preferably from about 0.4-0.8% by weight of an oxidant with the starting composition. The percents by weight can be based upon either the volume or the weight of the starting composition as the density of the starting composition is about 1 g/L. These amounts can be readily varied to yield a product having a color suitable for a particular application. The preferred oxidants include hydrogen peroxide, Groups I and II metal peroxides (such as sodium peroxide and calcium peroxide), and mixtures of the foregoing, with hydrogen peroxide being particularly preferred. As used herein, all references to weight percents of oxidant are calculated assuming 100% pure oxidant. Those skilled in the art will understand that these percentages can be readily converted to adjust for other concentrations of oxidant solutions. For example, 0.5% (w/v) of 100% H₂O₂ can be converted to the equivalent 1.5% (w/v) of a 34% H₂O₂ solution to take into account commercially available H₂O₂ solutions of varying concentrations of H₂O₂.

It is preferred that, prior to the aforementioned oxidant-mixing step, the starting red blood cell-containing composition be heated to a sufficient temperature and for a sufficient period of time so as to inactivate the naturally-occurring peroxidase enzymes. This step eliminates the need for adding high concentrations of the oxidant to the compositions as the peroxidases will no longer be available to decompose the oxidant. Preferably, the starting composition is heated to a temperature of from about 50-80° C., and more preferably from about 58-75° C. This temperature should be maintained for a period of time of from about 5-30 minutes, and preferably from about 8-18 minutes.

Before the oxidant is added to the starting composition, the temperature of the solution is reduced to a temperature of from about 35-50° C., and the resulting mixture is agitated for about 15-20 minutes. Unlike prior art methods, the instant processes do not require a so-called “pH reversal,” thus saving in processing time as well as in the expense of acids and bases for effecting the pH reversal. Therefore, throughout the processes of the instant invention, the pH of the composition will not change by more than about two pH units, preferably by no more than about one pH unit, and more preferably the pH will remain essentially constant.

The resulting decolorized liquid products can be maintained in liquid form or can be dried by conventional drying means (e.g., a spray dryer) to yield a powder having a light color and a mild flavor. Prior to drying, the decolorized liquid can be treated in various manners in order to yield a product suitable for a particular application. For example, for applications where a highly soluble product is desired, the decolorized liquid is subjected to an enzymatic hydrolysis process in order to increase the solubility of the product. Or, if desired, the hydrolysis process can be carried out on the starting composition prior to mixing of the oxidant therewith. Also, if necessary for a particular process, the pH of the product can be adjusted with an acid or base.

Due to the foregoing processing conditions, the naturally occurring proteins and fats contained in the starting compositions are not destroyed, and the heme (and therefore the iron) of the starting compositions is not removed. Thus, the decolorized blood products of the invention will retain at least about 75% of the protein, preferably at least about 85% of the protein, and more preferably at least about 95% of the protein of the starting composition. The decolorized blood products will also retain at least about 75% of the iron, preferably at least about 85% of the iron, and more preferably at least about 95% of the iron of the starting composition. Even more preferably, the decolorized blood products will retain essentially all of the iron and protein of the starting composition. The foregoing concentrations are all determined by standard methods conventionally used in the art.

Also as a result of the processing conditions, the processes do not result in the formation of undesirable by-products such as free heme and excess quantities of oxidant in the product which must be removed after the decolorization process. Therefore, the decolorized products will have less than about 0.5% by weight free heme, and preferably less than about 0.1% by weight free heme, based upon the total weight of the product taken as 100% by weight, as opposed to as much as 5% by weight free heme if the starting material was processed under conventional methods in the art. The term “free heme” as used herein refers to heme which is unbound from hemoglobin, but still an intact molecule.

The quantity of oxidant remaining in the final decolorized products, without any treatment to remove excess oxidant, is less than about 0.02% by weight, and preferably less than about 0.002% by weight, based upon the total weight of the product taken as 100% by weight, and would even more preferably be determined to be undetectable by standard methods conventionally used in the art.

Finally, the products have extremely low bacterial counts. For example, the products will have a Staphylococcus count of less than about 3 cfu/g, and preferably a standard plate count of less than about 10,000 cfu/g.

### DETAILED DESCRIPTION OF THE PREFERRED EMBODIMENTS

### EXAMPLES

The following examples set forth preferred methods in accordance with the invention. It is to be understood, however, that these examples are provided by way of illustration and nothing therein should be taken as a limitation upon the overall scope of the invention.

### EXAMPLE 1

### Decolorization of Porcine Whole Blood

Porcine whole blood (having a natural pH of 7.3) was treated with 0.4% sodium citrate (w/v). The resulting solution was diluted with tap water at a 1:1 volume basis. The solution was then heated to 63° C. by a water bath, and the temperature was maintained for 8 minutes. The heat source was turned off, and the solution was allowed to cool to about 45° C. Hydrogen peroxide (0.7% w/v of pure hydrogen peroxide, which is equivalent to 2.3% of 30% hydrogen peroxide) was added to the cooled solution while agitating the solution. The color change was monitored, and the solution was mixed for 20 minutes. During this time, the color changed from blood red to chocolate colored, then to dark yellowish, and finally to a light yellow color.

The final decolorized blood product was a yellowish liquid having a mild flavor and a pH of 7.0. The product was analyzed to determine whether there was any hydrogen peroxide remaining in the product. This was carried out by adding 0.01 M KMnO₄ to the diluted solution (1:300) and observing whether a color change took place. This test indicated that there was no hydrogen peroxide remaining in the product. The protein values of the decolorized product was compared to the protein values of normal whole porcine blood. The difference between the two samples was less than 6% on a dry basis. The liquid product was then heated to 90° C. in a water bath and maintained at this temperature for 1 hour to form a protein gel.

### EXAMPLE 2

### Decolorization of Porcine Red Blood Cells

A porcine red blood cell fraction (having a natural pH of 7.1) was separated from the plasma and diluted with tap water at a 1:3 volume basis. The solution was then heated to 63° C. by a water bath, and the temperature was maintained for 9 minutes. The heat source was turned off, and the solution was allowed to cool to about 45° C. Hydrogen peroxide (0.5% w/v of pure hydrogen peroxide, which is equivalent to 1.7% of 30% hydrogen peroxide) was added to the cooled solution while agitating the solution. The color change was monitored and the solution was mixed for 15 minutes. During this time, the color changed from blood red to chocolate colored, and then to a yellowish color. The solution was then homogenized for 5 minutes at 6,000 rpm.

The final decolorized blood product was a yellowish liquid having a mild flavor and a pH of 7.0. The product was analyzed to determine whether there was any hydrogen peroxide remaining in the product. This was carried out with a 0.01 M KMnO₄ solution against the diluted solution (1:300). There was no hydrogen peroxide remaining in the product. The SPC (standard plate count) and Staph counts were each less than 100 colony forming units (cfu) per ml of the decolorized porcine red blood cells compared to greater than 2 billion and greater than 20 million, respectively, per milliliter of normal porcine red blood cells which were subjected to the same storage and shipping conditions as the processed red blood cell fraction before the tests. The liquid product was then heated to 90° C. with a water bath and maintained at this temperature for 1 hour to form a protein gel.

### EXAMPLE 3

### Decolorization of Porcine Plasma at 60° C.

Porcine plasma having a natural pH of 7.6 was heated to 60° C. by a water bath and the temperature was maintained for 9 minutes. The heat source was turned off, and the solution was allowed to cool to about 43° C. Hydrogen peroxide (0.5% w/v of pure hydrogen peroxide, which is equivalent to 1.7% of 30% hydrogen peroxide) was added to the cooled solution while agitating the solution. The color change was monitored, and the solution was mixed for 15 minutes. During this time, the color became much lighter.

The final decolorized product was a light-colored liquid, had a mild flavor, and had a pH of 7.5. The product was analyzed to determine whether there was any hydrogen peroxide remaining in the product. This was carried out with a 0.01 M KMnO₄ solution against the diluted solution (1:100). There was no hydrogen peroxide remaining in the product. The resulting solution was then homogenized for 2 minutes at 5,000 rpm. The protein values of the decolorized product were compared to the protein values of normal porcine plasma. The difference between the two samples was less than 4% on a dry basis.

### EXAMPLE 4

### Decolorization of Bovine Whole Blood

Bovine whole blood (having a natural pH of 7.5) was treated with 0.4% sodium citrate (w/v). The resulting solution was diluted with tap water at a 1:1 volume basis. The solution was then heated to 63° C. by a water bath, and the temperature was maintained for 9 minutes. The heat source was turned off, and the solution was allowed to cool to about 45° C. Hydrogen peroxide (0.5% w/v of pure hydrogen peroxide, which is equivalent to 1.7% of 30% hydrogen peroxide) was added to the cooled solution while agitating the solution. The color change was monitored, and the solution was mixed for 20 minutes. During this time, the color changed from blood red to a yellowish color.

The final decolorized blood product was a yellowish liquid having a mild flavor and a pH of 7.4. The product was analyzed to determine whether there was any hydrogen peroxide remaining in the product. This was carried out with 0.01 M KMnO₄ against the diluted solution (1:300). There was no hydrogen peroxide remaining in the product. The product was then centrifuged for 15 minutes at 4,000 rpm resulting in the formation of a pellet phase and a liquid phase. The pellet phase was not water soluble while the liquid phase was highly water soluble.

### EXAMPLE 5

### Decolorization of Turkey Whole Blood

Turkey whole blood (having a natural pH of 7.4) was treated with 0.3% sodium citrate (w/v). The resulting solution was diluted with tap water at a 1:1 volume basis. The solution was heated to 62° C. by a water bath, and the temperature was maintained for 8 minutes. The heat source was turned off, and the solution was allowed to cool to about 40° C. Hydrogen peroxide (0.5% w/v of pure hydrogen peroxide, which is equivalent to 1.7% of 30% hydrogen peroxide) was added to the cooled solution while agitating the solution. The color change was monitored, and the solution was mixed for 20 minutes. During this time, the color changed from blood red to a light yellowish color.

The final decolorized blood product was a yellowish liquid having a mild flavor and a pH of 7.2. The product was analyzed to determine whether there was any hydrogen peroxide remaining in the product. This was carried out with 0.01 M KMnO₄ against the diluted solution (1:300). There was no hydrogen peroxide remaining in the product.

### EXAMPLE 6

### Decolorization of Chicken Whole Blood

Chicken whole blood (having a natural pH of 7.3) was treated with 0.3% sodium citrate (w/v). The resulting solution was diluted with tap water at a 1:1 volume basis. The solution was heated to 63° C. by a water bath, and the temperature was maintained for 6 minutes. The heat source was then turned off, and the solution was allowed to cool to about 40° C. Hydrogen peroxide (0.5% w/v of pure hydrogen peroxide, which is equivalent to 1.7% of 30% hydrogen peroxide) was added to the cooled solution while agitating the solution. The color change was monitored, and the solution was mixed for 20 minutes. During this time, the color changed from blood red to chocolate colored, then to dark yellowish, and finally to a light yellowish color.

The final decolorized blood product was a yellowish liquid having a mild flavor and a pH of 7.0. The product was analyzed to determine whether there was any hydrogen peroxide remaining in the product. This was carried out with 0.01 M KMnO₄ against the diluted solution (1:300). There was no hydrogen peroxide remaining in the product.

### EXAMPLE 7

### Decolorization of Porcine Red Blood Cells and Hydrolysis of the Decolorized Product

A porcine red blood cell fraction (having a natural pH of 7.1) was separated from the plasma and diluted with tap water at a 1:3 volume basis. The solution was then heated to 63° C. by a water bath, and the temperature was maintained for 9 minutes. The heat source was turned off, and the solution was allowed to cool to about 45° C. Hydrogen peroxide (0.5% w/v of pure hydrogen peroxide, which is equivalent to 1.7% of 30% hydrogen peroxide) was added to the cooled solution while agitating the solution. The color change was monitored, and the solution was mixed for 15 minutes. During this time, the color changed from blood red to chocolate colored, and finally to a yellow color. NoVo Pro-D (an enzyme available from NoVo Nordisk A/S, Denmark) was added to the decolorized red blood cell solution at a rate of 4 g of enzyme per kg of protein. The resulting mixture was then heated to 55° C. and maintained at this temperature for 2.5 hours while continually agitating the mixture. The mixture was heated to 85-90° C. for 15 minutes to inactivate enzyme. The solution was then cooled to room temperature.

The final decolorized blood product was a yellowish liquid. The product was analyzed to determine whether there was any hydrogen peroxide remaining in the product. This was carried out with 0.01 M KMnO₄ against the diluted solution (1:300). There was no hydrogen peroxide remaining in the product. The solution was dried in an oven overnight at 98° C. The resulting solid was ground into a yellowish powder which was water soluble. The product was then analyzed for its contents, the results of which are set forth in Table 1.

TABLE 1

| COMPONENT | QUANTITY |
|---|---|
| Protein | 92.4%^{a} |
| Acid Hydrolysis Fat | 1.27%^{a} |
| Ash^{b} | 4.37%^{a} |

^{a}Percent by weight, based on the total weight of the solid product taken as 100% by weight.
^{b}Determined by heating 1 g of powder in a muffle oven at 600° F. to remove all organic material and measuring quantity of product remaining.

### EXAMPLE 8

### Hydrolysis of Turkey Whole Blood and Decolorization of the Hydrolyzed Product

Turkey whole blood was diluted with tap water (having a natural pH of 7.4) at a 1:1 volume basis. The solution was then heated to 62° C. by a water bath, and the temperature was maintained for 8 minutes. The heat source was turned off, and the solution was allowed to cool to 50° C. Alcalase 2.4 (an enzyme available from NoVo Nordisk A/S, Denmark) was added to the solution at a rate of 1.5 g of enzyme per kg of protein. The resulting mixture was heated to 50° C. and maintained at this temperature for 25 minutes. Hydrogen peroxide (0.5% w/v of pure hydrogen peroxide, which is equivalent to 1.7% of 30% hydrogen peroxide) was added to the cooled solution while agitating the solution. The color change was monitored, and the solution was mixed for 8 minutes. During this time, the color changed from blood red to a yellowish color, and a foam formed on the surface of the solution. NoVo Pro-D was added to the resulting decolorized product at a rate of 2 g of enzyme per kg of protein, and the resulting mixture was heated to 50° C. and maintained at this temperature for 1 hour. The mixture was then heated to 90° C. for 15 minutes to inactivate the enzymes. At this point, the foam had almost completely disappeared. The solution was cooled to room temperature.

The final decolorized blood product was a yellowish liquid. The product was analyzed to determine whether there was any hydrogen peroxide remaining in the product. This was carried out with 0.01 M KMnO₄ against the diluted solution (1:300). There was no hydrogen peroxide remaining in the product.

### EXAMPLE 9

### Hydrolysis of Bovine Whole Blood and Decolorization of the Hydrolyzed Product

Bovine whole blood (having a natural pH of 7.5) was diluted with tap water at a 1:1 volume basis. The solution was then heated to 63 ° C. by a water bath, and the temperature was maintained for 9 minutes. The heat source was turned off, and the solution was allowed to cool to about 50° C. Alcalase 2.4 was added to the solution at a rate of 1.5 g of enzyme per kg of protein. The resulting mixture was then heated to 50° C. and maintained at this temperature for 30 minutes. Hydrogen peroxide (0.5% w/v of pure hydrogen peroxide, which is equivalent to 1.7% of 30% hydrogen peroxide) was added to the solution while agitating the solution. The color change was monitored, and the solution was mixed for 6 minutes. During this time, the color changed from blood red to a yellowish color, and a foam formed on the surface of the solution. NoVo Pro-D was added to the resulting decolorized product at a rate of 2 g of enzyme per kg of protein, and the resulting mixture was heated to 50° C. and maintained at this temperature for 1 hour. The mixture was then heated to 90° C. for 15 minutes to inactivate the enzymes. At this point, the foam had almost completely disappeared. The solution was then cooled to room temperature.

The final decolorized blood product was a yellowish liquid and had a natural pH of 7.3. The product was analyzed to determine whether there was any hydrogen peroxide remaining in the product. This was carried out with 0.01 M KMnO₄ against the diluted solution (1:300). There was no hydrogen peroxide remaining in the product.

### EXAMPLE 10

### Hydrolysis of Porcine Whole Blood and Decolorization of the Hydrolyzed Product

Porcine whole blood (having a natural pH of 7.3) was diluted with tap water at a 1:1 volume basis. The solution was then heated to 50° C. by a water bath and Alcalase 2.4 was added to the solution at a rate of 1.5 g of enzyme per kg of protein. The resulting mixture was then heated to 50° C. and maintained at this temperature for 30 minutes. The solution was then heated to 64° C. and maintained at this temperature for 10 minutes, followed by cooling to about 50° C. Hydrogen peroxide (0.5% w/v of pure hydrogen peroxide, which is equivalent to 1.7% of 30% hydrogen peroxide) was added to the cooled solution while agitating the solution. The color change was monitored, and the solution was mixed for 8 minutes. During this time, the color changed from blood red to a yellowish color, and a foam formed on the surface of the solution. NoVo Pro-D was added to the resulting decolorized product at a rate of 2 g of enzyme per kg of protein, and the resulting mixture was maintained at 50° C. for 1 hour. The mixture was then heated to 90° C. for 15 minutes to inactivate the enzymes. At this point, the foam had almost completely disappeared. The solution was cooled to room temperature.

The final decolorized blood product was a yellowish liquid having a pH of 6.5. The product was analyzed to determine whether there was any hydrogen peroxide remaining in the product. This was carried out with 0.01 M KMnO₄ against the diluted solution (1:300). There was no hydrogen peroxide remaining in the product.

### EXAMPLE 11

### Decolorization of Porcine Plasma at 52° C.

Porcine plasma having a natural pH of 7.2 was heated to 52° C. by a water bath and this temperature was maintained for 30 minutes. Hydrogen peroxide (0.1% w/v of pure hydrogen peroxide, which is equivalent to 0.3% of 30% hydrogen peroxide) was added to the solution while agitating. The solution was mixed for 15 minutes while the color change was monitored. During this time, the color changed to a light chocolate color solution having a pH of 7.2. The product was analyzed to determine whether there was any hydrogen peroxide remaining in the product. This was carried out with 0.01 M KMnO₄ against the diluted solution (1:200). There was no hydrogen peroxide remaining in the product. The solution was dried in an oven at 98° C. overnight, with the resulting solid product being ground into a light yellowish powder. The color of the powder was lighter than the color of normal porcine plasma powder processed under the same process conditions without hydrogen peroxide.

### EXAMPLE 12

### Large Scale Decolorization of Porcine Whole Blood

This test was conducted as a scaled-up process. Porcine whole blood was treated with 0.4% sodium citrate (w/v). The resulting solution was diluted with 45° C. tap water (having a natural pH of 7.3) at a 1:0.75 weight basis. The solution was heated to 63° C. in a stainless steel tank equipped with a heat source and stirring mechanism.

This temperature was maintained for 15 minutes. The heat source was turned off and another 25% of tap water (at the temperature at which it came from the faucet) was added to the mixture to bring the porcine whole blood to tap water ratio to 1:1 The solution was allowed to cool to 45° C. Hydrogen peroxide (0.5% w/w of pure hydrogen peroxide, which is equivalent to 1.5% of 34% hydrogen peroxide) was added to the cooled solution while agitating the solution. The color change was monitored, and the solution was mixed for 20 minutes. During this time, the color changed from blood red to chocolate colored, to dark yellowish, and finally to a light yellow color.

The final decolorized blood product was a yellowish liquid having a mild flavor and a pH of 7.0. The product was analyzed to determine whether there was any hydrogen peroxide remaining in the product. This was carried out with 0.01 M KMnO₄ against the diluted solution (1:300). There was no hydrogen peroxide remaining in the product. The large batch of solution was spray dried into a powder having a light color and mild flavor. The contents of the product were analyzed, and those results are set forth in Table 2. The resulting powder was mixed with water to achieve a solution having 20% solids (w/w) and a pH of 6.9. This solution was heated to 90° C. with a water bath and maintained at this temperature for 1 hour to form a protein gel.

TABLE 2

| COMPONENT | QUANTITY |
|---|---|
| Crude Protein | 88.8% |
| Acid Hydrolysis Fat | 0.72% |
| Moisture | 4.32% |
| Acid Detergent Fiber | 0.37% |
| Ash | 6.98% |
| Phosphorus | 1.08% |
| Sulfur | 0.60% |
| Potassium | 0.95% |
| Copper | 7 ppm |
| Iron | 2,164 ppm |
| Zinc | 21 ppm |
| Calcium | 0.10% |
| Sodium | 1.68% |
| SPC | 3000 cfu/g |
| Coliforms | <3 cfu/g |
| Salmonella | Negative^{a} |
| E. Coli | <3 cfu/g |

^{a}using 25 g sample

### EXAMPLE 13

### Decolorization of Porcine Whole Blood Without Water Dilution of Starting Sample

Porcine whole blood with a natural pH of 7.4 was heated to 71 ° C. by a water bath, and the temperature was maintained for 2 minutes. The heat source was turned off and the solution was allowed to cool to about 48° C. Hydrogen peroxide (0.6% w/v of pure hydrogen peroxide, which is equivalent to 2.0% of 30% hydrogen peroxide) was added to the cooled solution while agitating the solution. The color change was monitored while the solution was mixed for 20 minutes forming a protein slurry having small particles. During this time, the color changed from blood red to a yellowish color.

The product was analyzed to determine whether there was any hydrogen peroxide remaining in the product. This was carried out with 0.01 M KMnO₄ against the diluted solution (1:200). There was no hydrogen peroxide remaining in the product. The liquid product was dried overnight in an oven heated to 95° C. The resulting solid was ground into a light yellowish powder.

We claim:

1. A decolorized blood product formed by decolorizing a starting composition comprising a blood component and having a protein content, said decolorized product retaining at least about 75% of the protein content of said starting composition.

2. The product of claim 1, said product retaining at least about 85% of said protein content of said starting composition.

3. The product of claim 1, said starting composition having an iron content and said product retaining at least about 75% of the iron content of said starting composition.

4. The product of claim 1, said product having less than about 0.5% by weight free heme, based upon the total weight of the product taken as 100% by weight.

5. The product of claim 1, said product having less than about 0.02% by weight of said oxidant immediately after said decolorizing, said percent by weight being based upon the total weight of the product taken as 100% by weight.

6. The product of claim 1, said product having a Staphylococcus count of less than about 3 cfu/g.

7. The product of claim 1, said starting composition comprising red blood cells.

8. A decolorized blood product formed by decolorizing a starting composition comprising a blood component and having an iron content, said decolorized product retaining at least about 75% of the iron content of said starting composition.

9. The product of claim 8, said starting composition comprising red blood cells.

10. The product of claim 8, said product having less than about 0.5% by weight free heme, based upon the total weight of the product taken as 100% by weight.

11. The product of claim 8, said product having less than about 0.02% by weight of said oxidant immediately after said decolorizing, said percent by weight being based upon the total weight of the product taken as 100% by weight.

12. The product of claim 8, said product having a Staphylococcus count of less than about 3 cfu/g.

13. The product of claim 8, said decolorized product retaining at least about 85% of the iron content of said starting composition.

14. A method of forming a decolorized blood product comprising mixing a starting composition comprising a blood component with less than about 3% by weight of an oxidant to yield said decolorized product, said percent by weight being based upon the volume or weight of the composition.

15. The method of claim 14, wherein said starting composition is mixed with less than about 1.0% by weight of an oxidant.

16. The method of claim 14, wherein said oxidant is H₂O₂.

17. The method of claim 14, said starting composition having peroxidase enzymes and further including the step of heating said starting composition to a temperature of from about 50-80° C. for a period of time sufficient to inactivate the peroxidase enzymes in said composition prior to said mixing step.

18. The method of claim 14, further including the step of hydrolyzing the product resulting from said mixing step so as to increase the water solubility of said product.

19. The method of claim 14, further including the step of hydrolyzing said starting composition prior to said mixing step so as to increase the water solubility of said product.

20. The method of claim 14, said starting composition having a protein content and the product resulting from said mixing step retaining at least about 75% of the protein content of said starting composition.

21. The method of claim 14, said starting composition having an iron content and the product resulting from said mixing step retaining at least about 75% of the iron content of said starting composition.

22. The method of claim 17, wherein the pH of said composition changes by less than about two pH units during said heating and mixing steps.

23. The method of claim of 14, wherein said starting composition comprises red blood cells.

24. A product in accordance with the method of claim 14.

25. The product of claim 24, wherein said mixing step comprises mixing less than about 1.0% by weight of an oxidant with said starting composition.

26. The product of claim 25, wherein said oxidant is H₂O₂.

27. The product of claim 24, said starting composition having peroxidase enzymes and further comprising the step of heating said starting composition to a temperature of from about 50-80° C. for a period of time sufficient to inactivate the peroxidase enzymes in said composition prior said mixing step.

28. The product of claim 24, wherein said starting composition comprises red blood cells.
